(19) United States
(12) Patent Application Publication
(10) Pub. No.: US 2016/0374149 A1
(43) Pub. Date: Dec. 22, 2016

(54) THERMAL FIBER CARPET STRUCTURE

(71) Applicant: APOLLO SUN GLOBAL CO., LTD., San Jose, CA (US)

(72) Inventor: RICHARD CHI-HSUEH, SAN JOSE, CA (US)

(21) Appl. No.: 15/085,078

(22) Filed: Mar. 30, 2016

Related U.S. Application Data
(60) Provisional application No. 62/230,919, filed on Jun. 17, 2015.

(51) Int. Cl. H05B 3/34

(52) U.S. Cl. CPC H05B 3/347; H05B 2203/015; H05B 2203/026

(57) ABSTRACT

A thermal fiber carpet structure has a heating layer sandwiched between two shell fabric layers. When winter comes, the carpet structure of the present invention is laid on the floor, and then power is supplied to conductive yarns of at least one heating fabric provided on the heating layer so that heating wires of the conductive yarns are energized to generate heat. The heat generated is spread upward and uniformly dispersed to each corner of indoor space. When user walks in the room, his soles of feet can feel immediately the temperature rise and hence the warmth. By the present invention, the indoor humidity decrease is slowed down, power consumption is reduce, energy saving and carbon reduction effect is achieved. Moreover, installation of the present invention is simple so as to reduce significantly construction cost and labor hours.

### CROSS REFERENCE TO RELATED APPLICATION

This application claims the benefits from U.S. Provisional Application No. 62/230,919, filed on 17 Jun. 2015, the subject matter of which is incorporated herein by reference.

### BACKGROUND OF THE INVENTION

Field of the Invention

The present invention relates to a thermal fiber carpet structure, more particularly to a thermal fiber carpet structure which is simple in installation and consumes less power, enables user feeling immediately the warmth and slow-down of decrease on indoor humidity, avoids noise generation.

Brief Description of Prior Art

When winter comes, climate becomes cold especially in the regions of high latitude, as there is few radiant heat coming from the sun in winter season, the chances that temperature drops below 0° C. are very often. Thus, buildings in high latitude region are usually provided with heating facilities. The heat sources of current heat facilities mainly come from electric heat, gas heat and geothermal water pipe, and the heat is delivered to each corner of the room through either air discharge openings or floor conduction mode. As hot air is lighter, hot air will rise to the upper part of indoor space, so hot air will not come down to the lower part until it fills up the upper part of indoor space. When hot air floats upward, user in the room cannot feel immediately the warmth rendered by the hot air.

Therefore, after startup of existing heating facilities, it usually takes a long time for indoor space to reach predetermined temperature in order to make user feel warm. Thus, existing heating facilities consume relative amount of energy such as electricity or gas during their operation, making them unable to keep up with the trend of meeting the EP issues of energy-saving and carbon reduction. Particularly, the host machine and pipe lines of the existing heating facilities are mostly installed in outdoor. When climate becomes severely cold, the problems of pipe freezing and worse hot-air delivery efficiency of heating facilities are often occurred and it takes much time for indoor space to be warmed. Moreover, existing heating facilities are often very noisy in running, and this may renders impact on environmental tranquility. In addition, when hot air is delivered and circulates in the indoor space, the indoor humidity of air is lowered down due to heating. Besides, the heating facilities might bring outside virus into interior to cause respiratory disease of human body.

Furthermore, existing heating facilities such as heaters, geothermal water pipes or geothermal heat furnace line are very complicated in construction and hence result in expensive construction cost. Taking geothermal water pipe as example, ground surface such as tiles or marbles should be dug up firstly in construction, and then the geothermal water pipe or geothermal heat furnace line can be embedded under the indoor floor. If the geothermal water pipe or the geothermal heat furnace line is damaged, the ground surface should be dug up again and then maintenance can be conducted, so this may cause big economic burden of user. Moreover, extra-large water heater, hot water pressure pump and large power supply unit should also be installed on outdoor side, and the power supply to these equipments is the power source of 110-220V which may generate electromagnetic wave in use and cause danger of electric shock. What is more, heating mode by burning hot water may consume huge power and hence pay enormous power fee.

In view of the disadvantages of the conventional heating facilities described above, the inventor of the present invention proposes the thermal fiber carpet structure of the present invention based on endless contemplation and effort, and according to the help of his abundant experience of manufacturing and product development in relevant field and professional acknowledge.

### SUMMARY OF THE INVENTION

The main object of the present invention is to provide a thermal fiber carpet structure which is simple in installation, low in power consumption, enables user feeling the warmth immediately and slow-down of indoor humidity decrease, and avoids noise generation.

In order to achieve above objects, the inventor of the present invention hereby proposes a thermal fiber carpet structure as described below.

The thermal fiber carpet structure of the present invention comprises:

two shell fabric layers, comprising a first shell fabric layer and a second shell fabric layer; and

a heating layer sandwiched between the first shell fabric layer and the second shell fabric layer; the heating layer has at least one heating fabric which includes a plurality of conductive yarns serving as woven yarns in a first direction, and a plurality of non-conductive yarns serving as woven yarns in a second direction, and the woven yarns in the first direction and the woven yarns in the second direction are interwoven together. The conductive yarn has a non-conductive main axis yarn and a heating wire spirally wound on the main axis yarn. A plurality of metal conductive wires are provided respectively on both side edges of the heating fabric, and the metal conductive wires are parallel to the woven yarns in the second direction and are interwoven with the woven yarns in the first direction so as to form conductive circuit. Moreover, the metal conductive wires provided respectively on both side edges of the heating fabric converge and connect to one ends of two conductive wires respectively, and the other ends of the two conductive wires are electrically connected to a socket. Furthermore, the first shell fabric layer is formed with a cut-out on the portion corresponding to the jacks of the socket so as to allow the jacks of the socket to be exposed.

According to the above thermal fiber carpet structure, the heating layer, the first shell fabric layer and the second shell fabric layer are integrally combined together.

According to the above thermal fiber carpet structure, the heating layer, the first shell fabric layer and the second shell fabric layer are separately provided.

According to the above thermal fiber carpet structure, the heating layer includes a plurality of heating fabrics, and a fixing substrate, on which the heating fabrics are fixed, is separately provided.

According to the above thermal fiber carpet structure, the diameter of the heating wire of the conductive yarn of the heating fabric is 0.02-0.12 mm.

According to the above thermal fiber carpet structure, per centimeter of the main axis thread has 70-125 turns of above heating wire of the conductive yarn of the heating fabric spirally wound on the surface.

According to the above thermal fiber carpet structure, the spreading width of the metal conductive wires on each of the side edges of the heating fabric is 0.6-1.0 cm.

According to the above thermal fiber carpet structure, the diameter of the metal conductive wire is 0.05-0.12 mm.

According to the above thermal fiber carpet structure, the thermal fiber carpet structure further comprises a power supply unit which transforms AC voltage into DC voltage. The power supply unit is connected to one end of a power cord, and a plug is connected to the other end of the power cord in order to plug in the socket of the heating layer. Moreover, the power supply unit is further connected with a temperature controller.

According to the above thermal fiber carpet structure, the second shell fabric layer is a heat insulation shell fabric layer.

In this manner, when winter comes, the carpet structure of the present invention is laid on floor, and then power is supplied to the conductive yarns of at least one heating fabric provided on the heating layer so that heating wire of the conductive yarns is energized to generate heat. The heat generated is spread upward and is uniformly dispersed to each corner of indoor space. When user walks in the room, his soles of feet can sense the temperature rise and hence feel immediately the warmth. Because heat is naturally spread from the lower part to the upper part of indoor space, the indoor humidity decrease can be slowed down. Moreover, the present invention adopts power supply of low voltage and small current to the heating fabric, power consumption can be reduced so as to achieve energy-saving and carbon reduction effect. In addition, the installation of the present invention is very simple by just laying the thermal fiber carpet structure on the floor, making it possible to reduce construction cost and labor hours significantly.

### BRIEF DESCRIPTION OF ACCOMPANYING DRAWING

FIG. 1 is a perspective exploded view of the whole thermal fiber carpet structure of the present invention;

FIG. 2 is a perspective exploded view of the present invention;

FIG. 3 is a view showing the heating fabric of the present invention in weaving state;

FIG. 4 is a front view of the conductive yarn of present invention;

FIG. 5 is a front view of the machine equipment for weaving the conductive yarn of the present invention.

### DETAILED DESCRIPTION OF PREFERRED EMBODIMENTS

The objects, the technical contents and the expected effect of the present invention will become more apparent from the detailed description of a preferred embodiment in conjunction with the accompanying drawings.

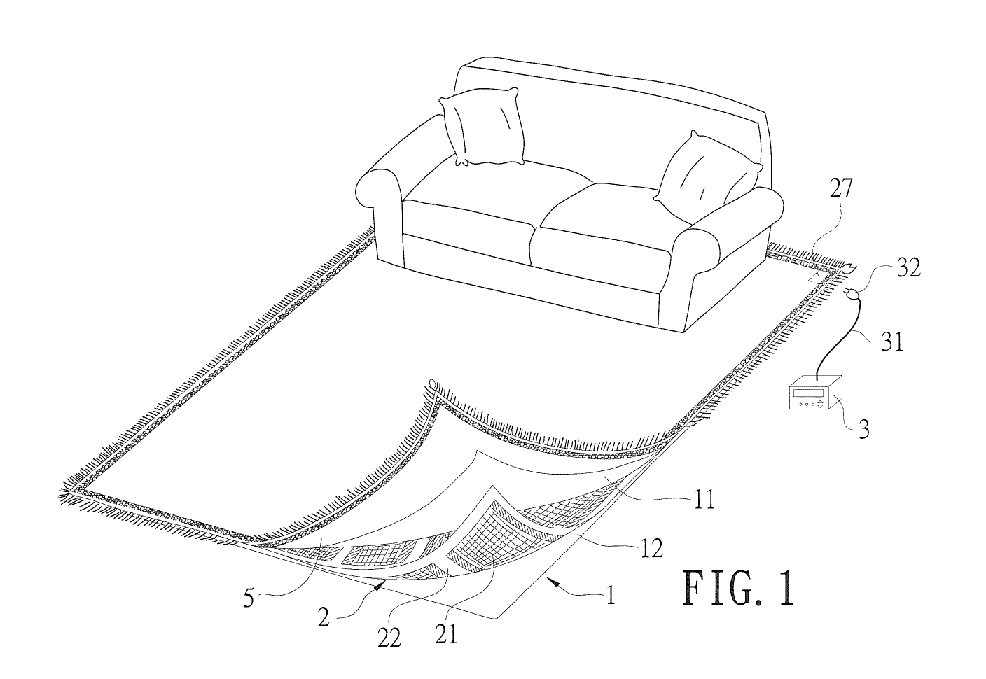

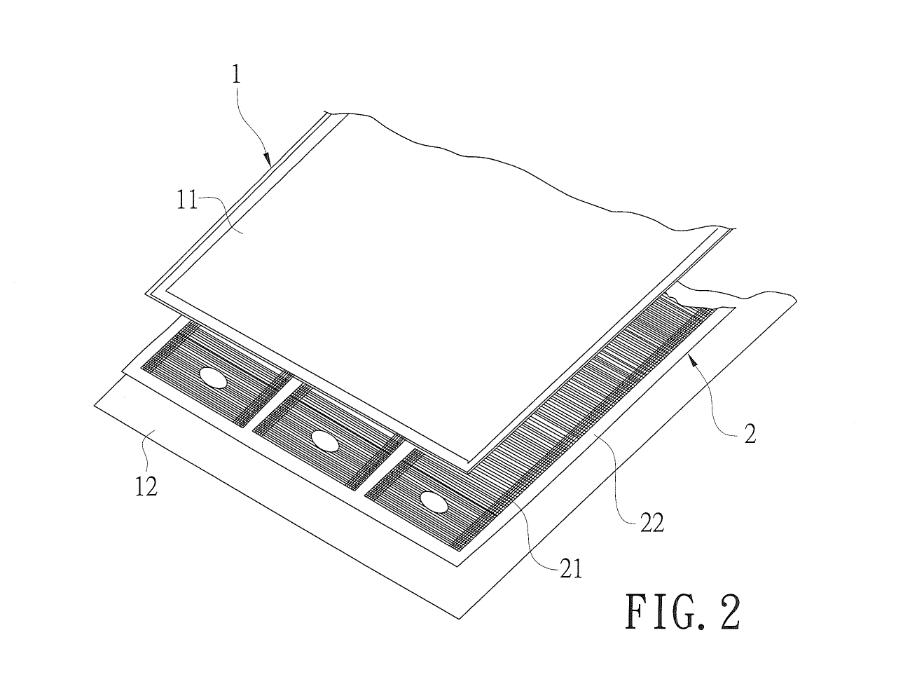

Referring to FIGS. 1 and 2, the thermal fiber carpet structure of the present invention mainly comprises:

two shell fabric layers (1) including a first shell fabric layer (11) and a second shell fabric layer (12) opposite to each other, and various kind of colors and patterns can also be sewn on the first shell fabric layer (11) and the second shell fabric layer (12), and the second shell fabric layer (12) located below is a heat insulation shell fabric layer with electric insulation and air permeability;

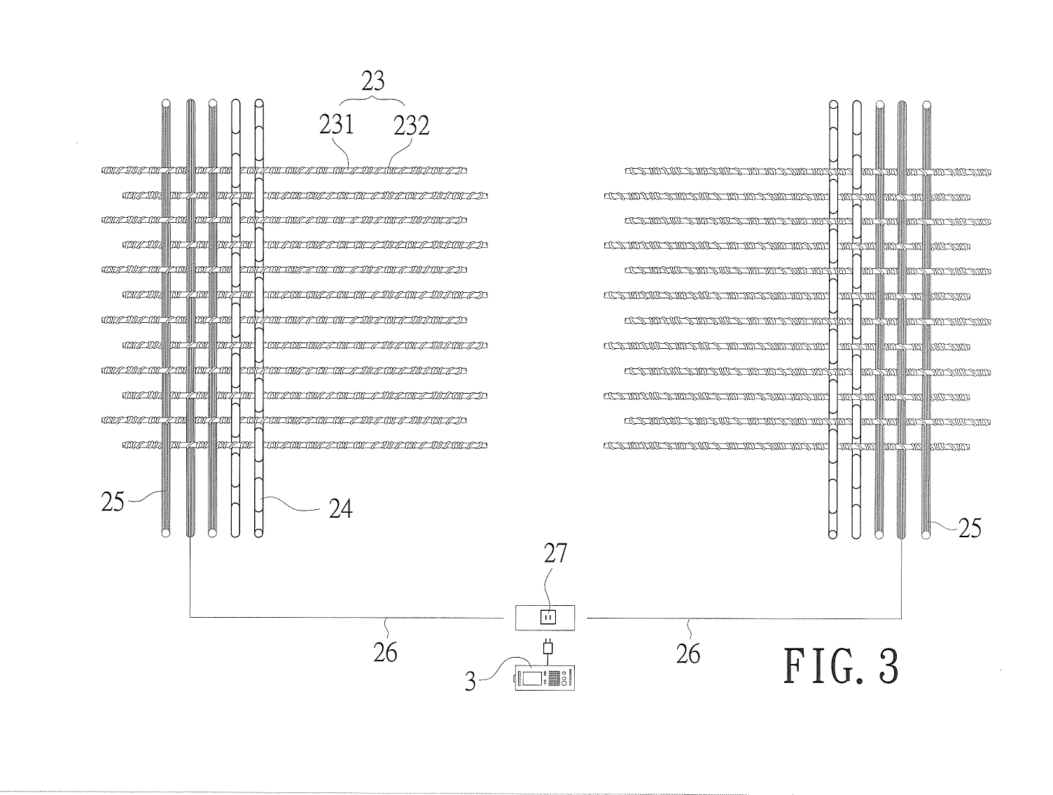

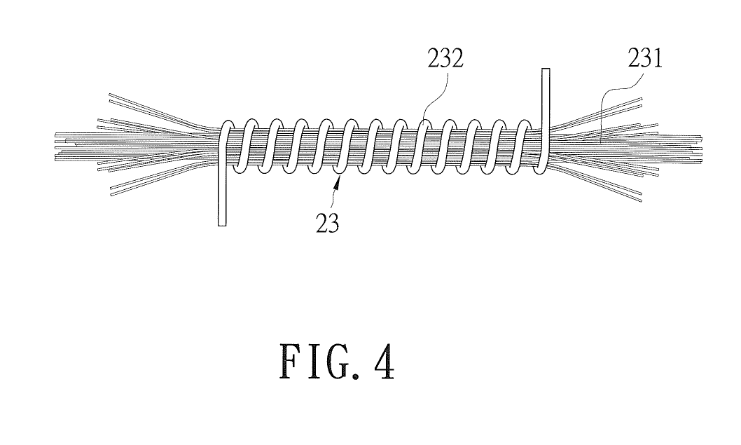

a heating layer (2) sandwiched between the first shell fabric layer (11) and the second shell fabric layer (12), and the first shell fabric layer (11) and the second shell fabric layer (12) are sewn integrally together. The heating layer (2) has at least one heating fabric (21). In a preferred embodiment of the present invention, a plurality of heating fabrics (21) are provided and the heating fabrics (21) are fixed on a fixing substrate (22) made of fiber cloth. Referring to FIGS. 3 and 4 too, the heating fabric (21) includes a plurality of conductive yarns (23) serving as woven yarns in a first direction, and a plurality of non-conductive multi-filament yarns (24) serving as woven yarns in a second direction. In the present invention, the woven yarns in the first direction are used as weft yarns and the woven yarns in the second direction are warp yarns, so that the plurality of conductive yarns (23) and the plurality of non-conductive multi-filament yarns (24) are interwoven together. The conductive yarn (23) has a multi-filament non-conductive main axis yarn (231) and a heating wire (232) spirally wound on the main axis yarn (231); the heating wire (232) capable of generating heat is made by anyone selected from gold, silver, copper, and tungsten-molybdenum alloy. Preferably, the diameter of the heating wire (232) of the conductive yarn (23) is 0.02-0.12 mm; per centimeter of the main axis yarns (231) has 70-125 turns of the heating wire (232) spirally wound on the surface thereof. Furthermore, the heating fabric (21) has a plurality of metal conductive wires (25) provided on both side edges, and the metal conductive wires (25) having a diameter preferably within the range of 0.05-0.12 m/m are made of Cu, Ag. The spreading width of the metal conductive wires (25) on each of the side edges of the heating fabric (21) is preferably 0.6-1.0 cm. The metal conductive wires (25) are parallel to the yarns (24) in the second direction and are interwoven with the conductive yarns (23) in the first direction so as to form conductive circuit. Moreover, the metal conductive wires (25) provided respectively on both side edges of the heating fabric (21) converge respectively and connect to one ends of two conductive wires (26), and the other ends of the two conductive wires (26) are electrically connected to a socket (27). Furthermore, the first shell fabric layer (11) is formed with a cut-out on the portion corresponding to the jacks of the socket (27) so as to allow the jacks of the socket (27) to be exposed;

a power supply unit (3), which is electrically connected to one end of a power cord (31). A plug (32) is connected to the other end of the power cord (31) so as to be plugged in the socket (27) of the heating layer (2). Moreover, the power supply unit (3) is connected with a temperature controller which can carry out temperature, timing and ON-OFF control. Furthermore, the power supply unit (3) is electrically connected with another plug so as to be plugged in a mains electricity socket, so as to transform the 110-220V AC power of mains electricity to 6V, 12V, 24V, 48V low voltage DC power.

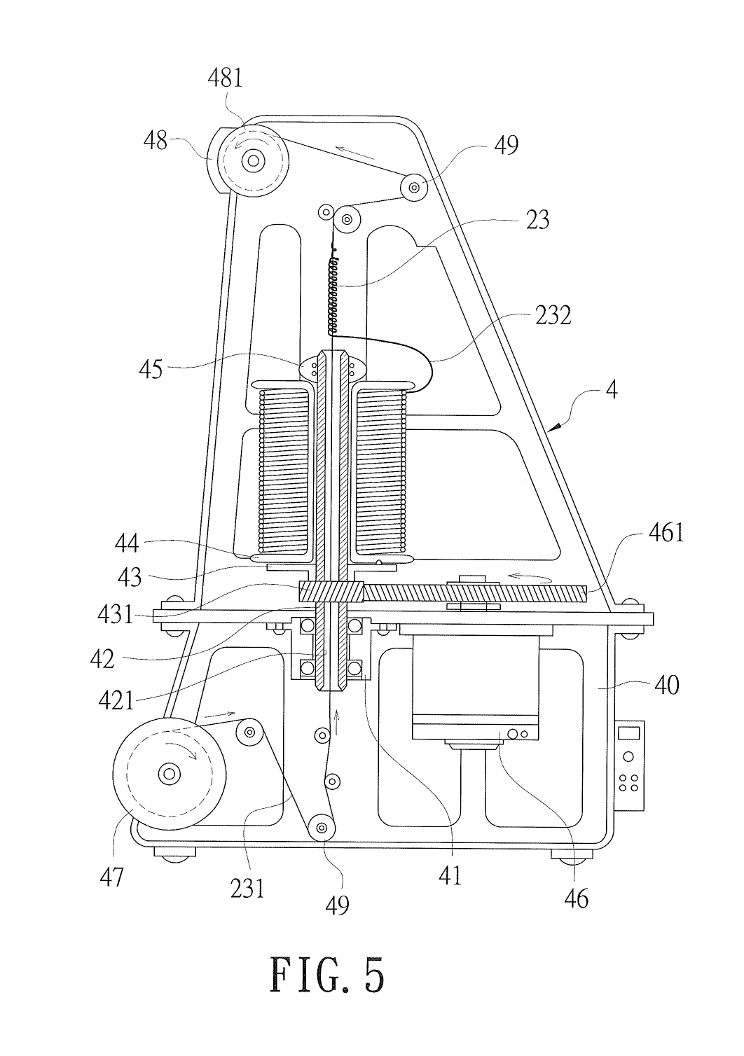

Referring to FIG. 5, a conductive yarn manufacturing equipment (4) for making conductive yarns (23) of the heating fabric (21) mainly comprises a base frame (40) on which a positioning seat (41) is fixed. An axle post (42) having a spindle hole (421) provided through the central axis is correspondingly assembled on the positioning seat (41). A turning block (43) is fitted on the axle post (42) and a turning wheel (431) is assembled on the bottom of the turning block (43). A wire disk (44) having the fine metal filament as the heating wire (232) wound thereon is combined over the turning block (43), and a limit block (45) for positioning the wire disk (44) is fitted on the axle post (42). A first power source (46) is mounted on the base frame (40) and the first power source (46) is assembled with a driving wheel (461) which meshes with the turning wheel (431). A spindle fixing disk (47) for winding the main axis yarns (231) is provided below the base frame (40). Furthermore, a second power source (48) is provided over the base frame (40) and a spindle coiling drum (481) is assembled with the second power source (48).

When making the conductive yarn (23), a spindle of non-conductive main axis yarns are fixed on the spindle fixing disk (47) beneath the base frame (40), so as to provide the main axis yarns (231) wound with the heating wire (232), and further to wind the heating wire (232) on the wire disk (44) located above the turning block (43). Next, the spindle coiling drum (481) assembled on the second power source (48) draws the main axis yarn (231) to pass through a number of guiding wheels (49) assembled on the base frame (40) for directional guiding, so that the main axis yarn (231) penetrates through the central spindle hole (421) of the axle post (42) and is drawn upward through the wire disk (44) having the heating wire (232) wound thereon. At this moment, the first power source (46) drives the driving wheel (461) which in turn moves the turning wheel (431) meshed therewith, making the wire disk (44) on the turning block (43) to be rotated with high speed, so that the heating wire (232) on the wire disk (44) is thrown out in parabola shape and is spirally wound on the outside surface of the main axis yarn (231) passing by, so as to form the conductive yarn (23) of the present invention. Next, the conductive yarn (23) is drawn upward by the spindle coiling drum (481) and is guided through a number of guiding wheels (49), and is finally wound on the spindle coiling drum (481) along predetermined direction. A length measuring device is provided on the spindle coiling drum (481) to measure the length of the conductive yarn (23) already wound on the spindle coiling drum (481). When the conductive yarn (23) wound on the spindle coiling drum (481) reaches a predetermined length, the spindle of the conductive yarn (23) can be removed and sent to textile factory to serve as weft yarn for weaving fabric, so the conductive yarn (23) as weft yarn and the non-conductive multi-filament yarn (24) as warp yarn are interwoven together to form the heating fabric (21) of the present invention.

When winter comes, the thermal fiber carpet structure of the present invention can be taken out for use, and an original indoor movable carpet (5) is opened first, then the thermal fiber carpet structure of the present invention is laid on the floor, next, the original carpet (5) is overlay over the thermal fiber carpet of the present invention. In turn, the plug (32) of the power supply unit (3) is plugged into the socket (27) of the heating layer (2), and the power supply unit (3) is plugged in the mains electricity socket, so that the 110-220V AC power is transformed into 12V, 24V DC power by the power supply unit (3), and the DC power is outputted through the socket (27) plugged by the plug (32) of the power supply unit (3) to the metal conductive wires (25) of the heating fabric (21) and then to the interwoven conductive yarns (23) through the metal conductive wires (25), so as to allow the heating wires (232) of the conductive yarns (23) to be energized to generate heat. At this moment, heat generated by the heating fabric (21) will transfer through the first shell fabric layer (11) and the upper carpet (5) and spread upward naturally. As the second shell fabric layer (12) located below is a heat insulation shell fabric layer, the heat generated from the heating fabric (21) can be collected to be transferred upwardly. Accordingly, every unit area of the carpet (5) can emit heat uniformly, making it possible to allow uniform temperature rise in every corner of the indoor space. Moreover, as the heat generated is dispersed from bottom to top, the soles of feet of user can directly sense the temperature rise and hence feel immediately the warmth. Moreover, as the heat is dispersed naturally to everywhere in the indoor space, forced draft device such as fan is not needed to deliver the heat to every corner of the indoor space, hence generation of disturbing noise can be avoid, and tempo of indoor humidity decrease can be slowed down so as to avoid the triggering of human respiratory disease problems. Moreover, the present invention adopts power supply of low voltage and small current to the heating fabric (21), power consumption can be reduced 25% compared to that of existing heating equipment, so as to achieve energy-saving and carbon reduction effect. The harm caused by electromagnetic wave can also be lowered and the danger of electric shock can also be avoided. In addition, the installation of the present invention is very simple by just opening the original carpet (5) and then laying the thermal fiber carpet structure below the original carpet (5), making it possible to reduce construction cost and labor hours significantly. It is possible to save the construction time and cost as much as 20% compared to that of the existing equipment. Besides, as the heating wire (232) of the conductive yarn (23) of the heating fabric (21) is spirally wound around the main axis yarn (231), the heating wire (232) can have very good stretch space during thermal expansion and contraction thereof What is more, by means of the structure of spirally winding the heating wire (232) around the main axis yarn (231), the heating wire (232) can be protected from easily pulling off, so that the heating fabric (21) of the present invention has soft cloth-like elasticity by which it is not only easy for laying but also simple for storing the carpet by rolling or stacking in warm season.

The abovementioned embodiment or drawings are not to limit the implementation aspect of the thermal fiber carpet structure. The two shell fabric layers (1) and the heating layer (2) are not limited to the type of sewing integrally together. The two shell fabric layers (1) and the heating layer (2) can also separately provided, so as to lay on the floor by stacking the second shell fabric layer (12), the heating layer (2), and the first shell fabric layer (11) in this sequence. In addition, the heating layer (2) of the present invention can omit the provision of the fixing substrate (22), and the heating fabric (21) is directly woven into required volume to serve as the heating layer (2). Moreover, the thermal fiber carpet can also provide in the application as window curtain, wall curtain, wall covering and cushion body. Appropriate variations and modifications conducted by those who has general knowledge in the art are still considered to be within the scope of the present invention.

Base on above structure and implementation, the present invention has the following advantages:
1. The thermal fiber carpet structure of the present invention is laid on the indoor floor, so when user walk on the carpet, the soles of his feet can directly sense the temperature rise and hence feel immediately the warmth. Therefore, the disadvantage that user cannot feel the warmth until it takes a long time to wait the indoor space filling with hot air can be avoided.

2. The thermal fiber carpet structure of the present invention is laid on the indoor floor, the heat generated is dispersed from bottom to top. Thus, the tempo of indoor humidity decrease can be slowed down effectively. As the present invention is installed in the interior, the problem that the heating equipment will draw outside virus into the internal room to trigger respiratory disease of human body can be further avoided, and generation of disturbing noise during operation of equipment can also be avoid.

3. The thermal fiber carpet structure of the present invention adopts power supply of low voltage, small current to generate heat, power consumption can be reduced 25% compared to that of existing heating equipment, so as to achieve energy-saving and carbon reduction effect. The harm caused by electromagnetic wave can also be lowered and the danger of electric shock can also be avoided.

4. The thermal fiber carpet structure of the present invention is very simple in the installation by just laying the thermal fiber carpet structure on the floor, making it possible to reduce construction cost and labor hours significantly. Comparing to the existing heating equipment, the construction time and cost can save more than 20%.

5. The thermal fiber carpet structure of the present invention is to allow the heating wires of the conductive yarns of the heating fabric to be spirally wound around the main axis yarn. Hence, the heating wires can have very good stretch space during thermal expansion and contraction thereof Moreover, by the structure of spirally winding the heating wires around the main axis yarns, the heating wires can be protected from easily pulling off, so the heating fabric of the present invention has soft cloth-like elasticity by which it is not only easy for laying but also simple for storing the carpet by rolling or stacking.

What is claimed is:

1. A thermal fiber carpet structure, comprising:
two shell fabric layers, comprising a first shell fabric layer and a second shell fabric layer; and
a heating layer sandwiched between the first shell fabric layer and the second shell fabric layer; the heating layer has at least one heating fabric which includes a plurality of conductive yarns serving as woven yarns in a first direction and a plurality of non-conductive yarns serving as woven yarns in a second direction, the woven yarns in the first direction and the woven yarns in the second direction being interwoven together; each conductive yarn having a non-conductive main axis yarn and a heating wire being spirally wound on the main axis yarn; a plurality of metal conductive wires being provided respectively on both side edges of the heating fabric, and the plurality of metal conductive wires being parallel to the woven yarns in the second direction and being interwoven with the woven yarns in the first direction so as to form conductive circuit; the metal conductive wires provided respectively on both side edges of the heating fabric converging respectively and connecting to one ends of two conductive wires, and the other ends of the two conductive wires being electrically connected to a socket; and the first shell fabric layer being formed with a cut-out on the portion corresponding to jacks of the socket so as to allow the jacks of the socket to be exposed.

2. The thermal fiber carpet structure as claimed in claim 1, wherein the heating layer, the first shell fabric layer and the second shell fabric layer are integrally combined together.

3. The thermal fiber carpet structure as claimed in claim 1, wherein the heating layer, the first shell fabric layer and the second shell fabric layer are separately provided.

4. The thermal fiber carpet structure as claimed in claim 1, wherein the heating layer includes a plurality of heating fabrics, and a fixing substrate, on which the heating fabrics are fixed, is separately provided.

5. The thermal fiber carpet structure as claimed in claim 1, wherein the diameter of the heating wires of the conductive yarns of the heating fabric is 0.02-0.12 mm.

6. The thermal fiber carpet structure as claimed in claim 1, wherein per centimeter of the main axis yarn has 70-125 turns of the heating wire of the conductive yarn of the heating fabric spirally wound on the surface.

7. The thermal fiber carpet structure as claimed in claim 1, wherein spreading width of the metal conductive wires on each of the side edges of the heating fabric is 0.6-1.0 cm.

8. The thermal fiber carpet structure as claimed in claim 1, wherein the diameter of the metal conductive wire is 0.05-0.12 mm.

9. The thermal fiber carpet structure as claimed in claim 1, wherein the thermal fiber carpet structure further comprises a power supply unit to transform AC voltage into DC voltage, the power supply unit being connected to one end of a power cord, and a plug being connected to the other end of the power cord in order to plug in the socket of the heating layer; and the power supply unit being further connected with a temperature controller.

10. The thermal fiber carpet structure as claimed in claim 1, wherein the second shell fabric layer is a heat insulation shell fabric layer.
